(19) United States
(12) Patent Application Publication
(10) Pub. No.: US 2003/0025909 A1
(43) Pub. Date: Feb. 6, 2003

(54) METHOD AND APPARATUS FOR MEASURING OF THE CONCENTRATION OF A SUBSTANCE IN A FLUID MEDIUM

(76) Inventor: HANS HALLSTADIUS, LUND (SE)

Correspondence Address: BURNS DOANE SWECKER & MATHIS L L P, POST OFFICE BOX 1404, ALEXANDRIA, VA, 22313-1404, US

(21) Appl. No.: 09/450,726

(22) Filed: Nov. 30, 1999

(30) Foreign Application Priority Data
Dec. 1, 1998 (SE) 9804149-4

(51) Int. Cl. G01N 21/00

(52) U.S. Cl. 356/436; 53/426; 53/167

(57) ABSTRACT

The invention relates to a method for determining the concentration of a substance in a sample in the presence of an interfering material by means of light absorption, and an apparatus therefore. By measuring the light absorbance at two different wavelengths the disturbing influences of interfering materials such as dust particles, dirt and bubbles may be compensated for. By also measuring the intensity of the light emitted from the light source but which has not yet passed through the measurement sample, simultaneously with the measurements of the absorbance of the light transmitted through the sample, at each wavelength measured, the true concentration may be determined by improved accuracy. The invention further relates to a method for packaging of a food product into packages, at least comprising the steps of sterilising a packaging material or packages by a sterilising medium containing a sterilising substance, filling of the sterilised packages with a food product and sealing of the packages, further comprising determining the concentration of the sterilising substance in the sterilising medium. It also relates to a machine arrangement for such packaging and filling of food products.

### FIELD OF INVENTION

The present invention relates to a method for determining the concentration of a substance in a sample in the presence of an interfering material, comprising at least the steps of directing light from a light source through the sample, measuring the absorbance of said light at a first wavelength or range of wavelengths, at which light is absorbed by said substance and interfering material, and at a second wavelength or range of wavelengths, at which light is absorbed by said interfering material but substantially not by said substance, and deriving from the measurements the required determination of the concentration of said substance corrected for the presence of said interfering material.

The invention also relates to an apparatus for carrying out the method for determining the concentration of a substance in a sample in the presence of an interfering material.

Furthermore, the invention relates to a method for packaging of a food product into packages comprising at least the steps of sterilising a packaging material or packages by a sterilising medium containing a sterilising substance, filling of the sterilised packages with a food product and sealing of the packages, the method further comprising determining the concentration of the sterilising substance in a sample of the sterilising medium. The invention also relates to a machine for carrying out such a method for packaging of a food product into packages.

### BACKGROUND OF INVENTION

In the process of packaging of food products it is important to keep the level of bacteria and other micro-organisms at a low level in order to provide food products with high quality and a long shelf life, allowing for long distance transport and distribution while the food product still can be kept fresh and unimpaired from bacterial attack. Depending on the food product to be packaged, the sterilisation operation is more or less critical. In particular regarding aseptic dairy products, i.e. dairy products for long term ambient storage, it is vital that the food product as well as the package has been completely sterilised before filling and sealing of the package and that the risk for re-contamination of food and packaging material is eliminated.

In food packaging processes of today (with the term “food” is meant all sorts of solid and liquid food, i.e. also juices, milk and other beverages) the packaging material or the ready-to-be-filled package is often sterilised by means of contacting with a fluid, liquid or gas-phase, sterilising medium. The packaging processes are often high speed continuous processes of the type form-fill-seal, i.e. processes wherein the packaging material in the form of a web or blank is continuously fed through a machine, sterilised by passing through a liquid solution of a quick-acting sterilising agent, alternatively by passing through a stream of gas-phase sterilising medium, dried or vented by sterile air, formed into the required shape for being filled, e.g. a cup, capsule or tube, filled with the food to be packaged and sealed, all steps under sterile conditions. Also, bottles or cups, manufactured by various moulding processes may need to be sterilised in the same way before filling with product. The contacting step can be carried out by means of submerging the whole package or packaging material into the liquid sterilising medium, as well as by means of spraying or painting the sterilising medium onto the packaging material or package wall, or alternatively by means of contacting with a flow of gaseous sterilising medium. Since the sterilising operation normally takes place just before filling and sealing of the package during a high-speed packaging process, it is important that the sterilising agent can be quickly dried away and removed from the packaging material before filling with the food product. On the other hand, it is crucial that there is enough sterilising agent in the solution or gas to efficiently and quickly kill all micro-organisms present on the packaging material. The important parameters to consider for sufficient and rational sterilisation are, thus, the concentration of the sterilising agent in the liquid or gas-phase medium, the temperature of the sterilising medium as well as of the packaging material and the contacting time between the sterilising medium and the packaging material. These parameters have to be balanced against the time required for drying or venting away the sterilising medium from the packaging material and against the desired speed of the packaging process in total. The sterilising agent mostly used in food packaging is hydrogen peroxide, since it is relatively cheap, quickly kills bacteria and other micro-organisms and is approved by the authorities for use in the food industry, thus fulfilling the needs of the packaging industry today. Another feasible such sterilising agent is ozone.

Hitherto, the concentration of the sterilising medium, in particular aqueous hydrogen peroxide, has only been roughly estimated at mixing of the sterilising agent and water and then only measured occasionally by means of old-fashioned laboratory titration methods. As a consequence, the sterilising agent is more or less added in the process according to rules of thumb and only roughly estimated to be within the required concentration limits. The risk for variations in the sterilising effect is great, since the sterilising solution is only measured once or twice a day and not continuously monitored. In order to compensate for variations in the concentration, a minimum contacting time and temperature has been established by experience and is firmly adhered to. There is, thus, a desire for a more exact method for measurement of the concentration, in order to enable optimisation of the sterilisation parameters and to save both time and energy in the sterilisation operation and, thus, to provide an improved and more cost-efficient sterilisation and packaging process.

Light absorption spectrophotometry, and especially UV-absorption spectrophotometry, is highly suitable for performing quantitative analysis of a light absorbing substance in a sample medium, because the light absorption of a substance is directly dependent on the concentration thereof, i.e. the concentration of the substance is inversely proportional to the height of the peaks in the plotted curve from the light intensity detector output signal. Moreover, light absorption methods are relatively easy to carry out, quick, reliable, reproducible and accurate.

All substances in solution or gas-phase absorb radiation at various characteristic wavelengths in the electromagnetic spectrum. In particular, most substances absorb UV-light in the UV portion of the spectrum.

It is normally considered that UV-light ranges from about 10 to about 400 nm, while visible light ranges from about 400 to about 750 nm. The UV-range is divided into the UVA, UVB and UVC spectra. UVA ranges from about 320 to about 400 nm, UVB from about 280 to about 320 nm and UVC from about 200 to about 280 nm. Chemical UV-analyses are normally carried out at wavelengths longer than 160 nm. However, at wavelengths shorter than 220 nm, it is necessary to carry out the analysis under oxygen-free conditions, i.e. in the absence of air or water, since the absorption of oxygen will otherwise disturb the measurement results and since oxygen dissociates and generates ozone when irradiated (also disturbing the measurements).

According to the traditional light absorption analysis methods, in particular UV-light absorption, the substance to be measured is dissolved or vaporised in a medium that absorbs much less at the same characteristic wavelength than the substance to be measured itself. The intensity of the light transmitted through the sample medium containing the substance to be measured is detected as well as the light transmitted through a reference sample of the medium not containing the substance, at the same characteristic wavelength. The two output signals, representing the light intensities, are used for calculation of the concentration of the substance according to the Beer-Lambert equation:

log I₀/=A(=Absorbance)=εL C i.e. I/I₀=10^{-εLC}

where I and I₀ are the intensities of the light transmitted through the sample and the reference sample respectively, ε is the absorption coefficient for the specific substance at a specific wavelength in a specific medium at a predetermined temperature, L is the length of the monitoring path through the sample to be measured and C is the concentration of the substance in the sample. Since the length of the monitoring path, i.e. the length of the measurement cell if used is a measurable constant, and since the absorption coefficients, ε, for various media and substances at different wavelengths are well known and documented, the light intensities I and I₀ can be continuously measured and, thus, the concentration of the substance in the medium be continuously monitored. The Beer-Lambert equation is valid for all mono-chromatic light, i.e. light of one specific wavelength, having a narrow spectral band width.

Calibration can for example take place by measurement of the light transmitted through a reference sample. Normally, such reference measurement can be carried out either with the same vessel or measurement cell as containing the sample medium, by regularly flowing the measurement vessel with the gas or liquid medium not containing the sample substance, or alternatively by measuring the reference sample in another, identical measurement cell. There is, however, a disadvantage with measuring through two different measurement cells, in that it may be difficult to ensure that both measurements are performed under exactly the same conditions.

However, a traditional light absorption measurement method, such as described above, would not work in a process of sterilisation of a packaging material, since interfering materials such as dirt and dust particles present in the sterilising fluid would absorb light as well and disturb the light absorption measurement results.

Such solid particles are always more or less present in the sterilising fluid in a packaging material sterilisation process. Packaging materials having a core layer of paperboard or carton contaminate the sterilising solution with fibre and dust particles. In all kinds of liquid sterilising media, air bubbles are formed, which would disturb the results as well. In a gas-phase sterilising medium, condensation droplets on the windows of the measurement vessel will disturb the measurements. Also soil and depositions on the measurement cell windows, in particular occurring when using a hot sterilising medium, would disturb the light intensity measurement results.

The Japanese patent application, JP-A-01244341, describes a method and instrument for measuring the concentration of ozone in a fluid medium by means of absorption measurements at two wavelengths, the fluid medium also containing other disturbing, light absorbing substances, such as chlorine, sulphur dioxide or nitrogen oxide. According to one embodiment, the first wavelength is 254 nm, at which both ozone and the other substances are absorbing, while the second wavelength is 184,9 nm, at which only the other substances are absorbing light. Measurements at a wavelength of 184,9 nm will, however, restrict the type of sample medium to those containing neither air nor water or moisture, since oxygen will react to form ozone under the influence of such UV short wavelength radiation. This will inevitably disturb the measurements if the substance to be determined absorbs light at the same wavelength range as ozone.

According to a second embodiment, the first wavelength is 254 nm, while the second wavelength is 436 or 546 nm, or both wavelengths are measured as a second and a third wavelength.

However, the dual wavelength measurement method, i.e. the method of measuring light absorption at two different wavelengths, still does not guarantee the accuracy needed for some measurement applications. The light source, providing the light to be transmitted through the sample medium, will not emit the same amount of light at different points in time. Typically, the light intensity will decrease with the age of the light source, but also, the intensity will vary with variations in the electric system and voltage supply. JP-A-01244341 mentions that according to prior art, when measuring at only one wavelength, the intensity of the light emitted directly from the lamp, before being transmitted through the sample, may also be measured in order to compensate for variations in the emissions from the lamp.

However, in JP-A-01244341 it is assumed that variations in the intensity of the light emitted from the lamp will be eliminated by measuring at two different wavelengths, since the intensity deviation would be the same at both wavelengths.

This is, however, not true and may only be assumed for some purposes where high accuracy is not needed, and when the two wavelengths are selected from a narrow part of the spectrum, i.e. lie relatively close to each other. We have found that for the purposes of exact determination of the concentration of a substance in a medium, it is necessary to compensate for the variations of the lamp at the first wavelength as well as the second. For our purposes, it is desirable to determine concentrations with an accuracy as high as +/−3%, preferably 2%.

Although it is generally known to measure the concentration of various substances in a liquid or gaseous medium by means of absorption spectrophotometry, it is hitherto unknown to measure the concentration of a sterilising agent in a sterilising medium in connection with the process of sterilising a packaging material for food packaging, by means of light absorption methods. There are no methods or instruments available on the market today for measuring the concentration of substances, such as for example hydrogen peroxide or ozone, with sufficient accuracy by means of light absorption spectrophotometry in the kind of contaminated sterilisation media as are used in the sterilisation of packaging materials.

Moreover, there has not previously been provided a universal method and a universal apparatus that functions equally well with sufficient accuracy, for measurement of different sterilising substances, such as ozone or hydrogen peroxide, in different fluid media, such as air, gas/vapour or aqueous solution, by means of light absorption spectrophotometry in the kind of contaminated sterilisation media as are used in the sterilisation of packaging materials.

The various commercially available instruments on the market today have too low accuracy for our purposes and are unduly expensive. They function by means of conductive methods and measure only very low concentrations.

It is, therefore, an object of the present invention to provide a method for determining the concentration of a light absorbing substance in a sample in the presence of an interfering material, which overcomes or alleviates the above mentioned problems.

It is an object of the invention to provide a method for determining the concentration of a light absorbing substance, that functions with sufficient accuracy, despite the presence of interfering materials, such as occasional gas bubbles, droplets, dirt, dust or deposition particles, in the measurement medium and on the measurement vessel windows.

It is further an object of the invention to provide such a method for measurement of the concentration of a light absorbing substance, that functions equally well in both aqueous and air-containing gas-phase media.

It is also an object of the invention to provide an apparatus for carrying out the method according to the invention.

In particular, it is an object of the invention to provide a method for packaging of a food product into packages, wherein the packaging material is sterilised in order to obtain prolonged shelf-life of the food product and wherein the concentration of the sterilising agent in the sterilising medium may be monitored and controlled within the desired concentration limits, with sufficient accuracy.

Furthermore, it is an object of the invention to provide a machine or arrangement for packaging of a food product into packages, having means for monitoring and keeping the concentration of the sterilising agent in the sterilising medium within the desired concentration limits, with sufficient accuracy.

### SUMMARY OF INVENTION

These objects are achieved according to the present invention by means of the method as specified in claim 1. By measuring the light absorbance at two different wavelengths the disturbing influences of reasonable amounts of interfering materials such as dust particles, dirt and gas bubbles may be compensated for. By measuring the intensity of the light emitted from the light source but which has not yet passed through the measurement sample, simultaneously with the measurements of the absorbance of the light transmitted through the sample, at each wavelength measured, the true concentration may be determined by improved accuracy. Variations in the intensity of light emitted from the light source will thus be compensated for.

Preferred and advantageous embodiments of the method according to the invention have further been given the characterising features as set forth in claims 2-12.

By selecting the first wavelength from the UV spectrum and the second wavelength from the visible spectrum, as set out in claim 2, the disturbing absorption from interfering material, such as dust particles, fibres, condensation droplets and lower amounts of gas bubbles, may be compensated for in the most efficient manner. The substances to be measured are often broad band UV-absorbing substances, such as for example ozone or hydrogen peroxide, which however absorb substantially less light, or no light at all, in the visible spectrum. The said type of interfering material, on the other hand, absorb substantially the same amount of light in the UV and in the visible spectrum.

Preferably, the first wavelength(s) is selected from between about 220 nm and about 320 nm, since this range is located sufficiently remote from the visible spectrum and since the type of broad band absorbing substances most commonly used, have their absorption maxima within this range of wavelengths. By measuring at wavelengths where the substance has adequate and sufficiently strong absorption, higher accuracy will be obtained. Of great importance is also at which wavelengths the light source emits light of sufficiently high intensity. The most preferred light source of those known on the market today, is the low pressure mercury lamp, which has a strong emission of light at 254 nm, more precisely at 253,7 nm. Accordingly, the most preferred first wavelength(s) is selected at about 254 nm. Another more moderate emission of light occurs at about 313 nm, which may also be preferred for some applications.

Preferably, the second wavelength(s) should then be measured among wavelengths of about 385 nm and longer, more preferably from wavelengths of between about 400 nm and 700 nm, and most preferably from about 436 nm and/or about 546 nm.

According to the preferred method as defined in claim 5, calibration is carried out by means of a measurement through a reference sample, containing the same fluid medium as the measurement sample but none, or substantially less, of the substance to be measured. By measuring the intensity of the light transmitted through the sample as well as through a reference sample, at the first as well as at the second wavelength(s), and by applying the obtained values to the Beer-Lambert equation, the light absorbance of the sample may be determined at each wavelength.

As explained above, the calibration measurement may take place in a different but identical measurement cell, containing reference sample only, or alternatively in the same reference cell, but at a different point in time. The latter method is preferred, since it provides higher security against differences in the flow of the samples and against differences between the two monitoring space windows.

The method functions particularly well for UV broad band absorbing substances, that do not absorb, or absorb substantially less, light in the visible spectrum. Most suitably, the concentration of hydrogen peroxide or ozone, as specified in claim 6, may be measured according to the method of the invention, since these substances have such UV broad band absorption properties. Hydrogen peroxide and ozone are also two of the most frequently used sterilising substances used in the food and food packaging industry.

In the food packaging industry, the sterilising agent is mostly carried by a fluid liquid or gas-phase medium, containing water, moisture and/or air. According to the preferred embodiment of claim 7, the medium is an aqueous medium. According to another preferred embodiment as defined in claim 8, the medium is a mixture of air and a gas-phase vapour of the sterilising substance, alternatively a mixture of air, aqueous moisture (steam) and the gaseous sterilising agent. Air and water are preferred since they are harmless media from both environmental and food hygienic point of views.

According to the embodiment of claim 9, the concentration in an aqueous sterilising medium, containing hydrogen peroxide as the sterilising agent, is preferably measured at a first wavelength of about 313 nm, while the second wavelength is selected from about 436 or about 546 nm. Aqueous hydrogen peroxide sterilising media normally require a concentration of 1-50 weight-% for sufficient sterilisation effect. A very common concentration used in the food packaging industry is about 35 weight-%. When hydrogen peroxide is combined as a sterilising agent together with sterilisation by means of UV-light radiation or the like, concentrations of hydrogen peroxide may be much lower, such as for example from 0,1-1 weight-%. For measurement of the higher concentrations of aqueous hydrogen peroxide, as are often used in the packaging industry today, it is preferred to measure the first wavelength absorbance at about 313 nm, since hydrogen peroxide absorbs more moderately at this wavelength and the output signals therefore more adequately reflect the absorption ratios. The length of the measurement cell may most suitably be from about 0,5 to about 5 mm.

For light absorbance measurements of ozone or gas-phase hydrogen peroxide the first wavelength is most advantageously selected from about 254 nm. The length of the monitoring path is preferably from about 10 to about 250 mm depending on the concentration in the sample medium, when measuring the absorbance of gas-phase hydrogen peroxide, as specified in claim 10. For measurement of ozone, however, the length of the monitoring path is preferably from about 0,5 to about 5 mm, as specified in claim 11, depending on the concentration in the sample medium.

If hot liquid sterilisation medium is used, it may be necessary to compensate for the higher temperature in the calculation of the concentration of sterilising substance, depending on which sterilising substance is used. The relation between the concentration C and the absolute temperature T can generally be expressed as

1/C=αe^{-1/T}.

wherein α is a linear constant.

Furthermore, if a particular liquid sterilising agent generates gas bubbles when heated, which is the case with aqueous hydrogen peroxide solution at about 70° C., it may be necessary to remove or at least reduce the amount of bubbles in the hot sterilising liquid before it is passed through the concentration measurement equipment, as defined in claim 12.

According to a further aspect of the invention, there is provided an apparatus for monitoring the concentration of a light-absorbing substance in a sample in the presence of an interfering material, as specified in claim 13.

Preferred and advantageous embodiments of the apparatus according to the invention have been given the characterising features as set forth in the claims 14-20.

As mentioned above and as defined in claims 14-15, the light source advantageously is of the type emitting light of wavelengths from between about 220 nm and about 320 nm, as well as light of a second wavelength or range of wavelengths of about 385 nm and longer. Most preferably, the light source providing light of such wavelengths is a low pressure mercury lamp.

Claim 16 defines a preferred apparatus according to the invention, comprising a light source, a monitoring path (L), measuring means in the form of detectors providing detector output signals, and computing means for deriving the true concentration with high accuracy by applying the Beer-Lambert equation to the output signals. The calibration measurement as described in claim 5, is carried out by means of detectors, detecting the light transmitted through a reference sample, containing the same fluid medium as the measurement sample but substantially less of the substance to be measured, the detectors being adapted to measure the light intensity at the first and second wavelength(s) respectively. By measuring the intensity of the light transmitted through the sample as well as through a reference sample, at the first as well as at the second wavelength(s), and by applying the obtained values to the Beer-Lambert equation, the light absorbance of the sample may be determined at each of the first and the second wavelengths.

When determining the concentration of ozone, preferably the length of the monitoring path is from about 0,5 to about 5 mm and the first and third detectors are adapted to measure the light intensity at about 254 nm, as defined in claim 17.

When determining the concentration of hydrogen peroxide in a gas-phase medium, preferably the length of the monitoring path is from about 10 to about 250 mm and the first and third detectors are adapted to measure the light intensity at about 254 nm, as defined in claim 18.

When determining the concentration of hydrogen peroxide in an aqueous medium, preferably the length of the monitoring path is from about 0,5 to about 5 mm and the first and third detectors are adapted to measure the light intensity at about 313 nm, as defined in claim 19.

If the amount of gas bubbles in a liquid sterilising medium becomes too high, which may be the case when for example an aqueous solution of about 35 weight % of hydrogen peroxide is heated to 50-70° C., the amount of gas bubbles may have to be reduced by separating the gas bubbles from the liquid before determining the concentration. The apparatus should then include a device for reducing the amount of bubbles as defined in claim 20.

Also, for some liquid sterilising media, such as with an aqueous solution of about 35 weight-% of hydrogen peroxide, the concentration at a specified wavelength may vary considerably with the temperature. Therefore, the concentration measurement apparatus should include a device for measuring the temperature of the liquid in order to compensate for such variations.

According to a further aspect of the invention, there is provided a method for packaging of a food product into packages, at least comprising the steps of sterilising a packaging material or packages by a sterilising medium containing a sterilising substance, filling of the sterilised packages with a food product and sealing of the packages, further comprising a method for determining the concentration of the sterilising substance in the sterilising medium, as defined in claim 21.

According to a still further aspect of the invention, there is provided a machine for packaging of a food product into packages comprising an apparatus for concentration determination, as defined in claim 22.

The method and apparatus for monitoring of the concentration according to the invention are especially suitable for use in methods and machines for the sterilisation of packaging material in the food packaging industry, since it provides high accuracy concentration measurements despite the presence of light-absorption interfering materials in the sterilising medium, thus enabling more reliable sterilisation and lower risk for sterilising agent residues (due to excess of sterilising agent) in the sterilised packages, as well as more efficient use of the sterilising agent.

### DETAILED DESCRIPTION

Further advantages and favourable characterising features in the method and apparatus according to the present invention will be apparent from the following detailed description with references to the accompanying drawings.

Though the invention will be described herein below with particular reference to an apparatus, it should nevertheless be observed that, in the broadest scope, the present invention is not restricted exclusively to this practical application, selected by way of example of one among many other conceivable arrangements, for carrying out the method according to the invention as defined in the appended patent claims.

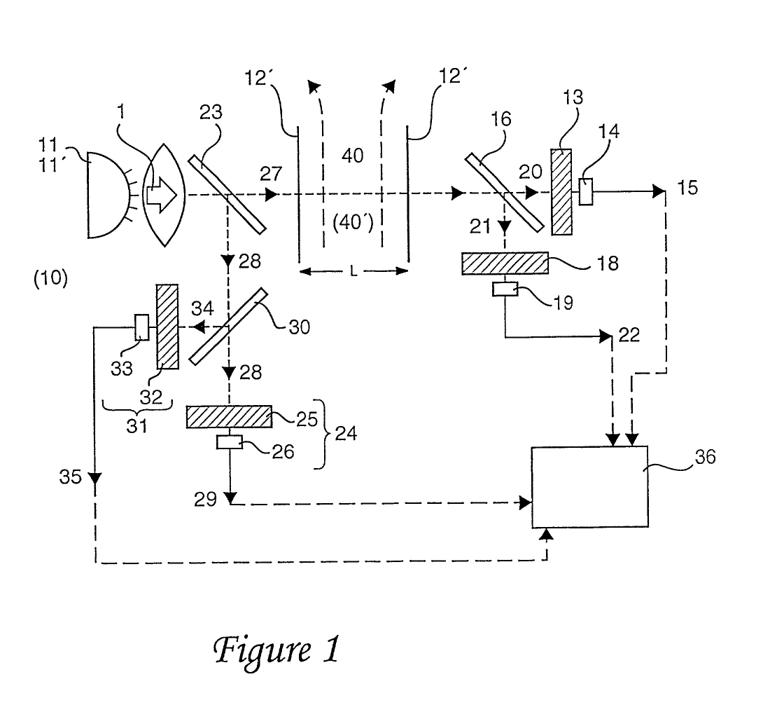

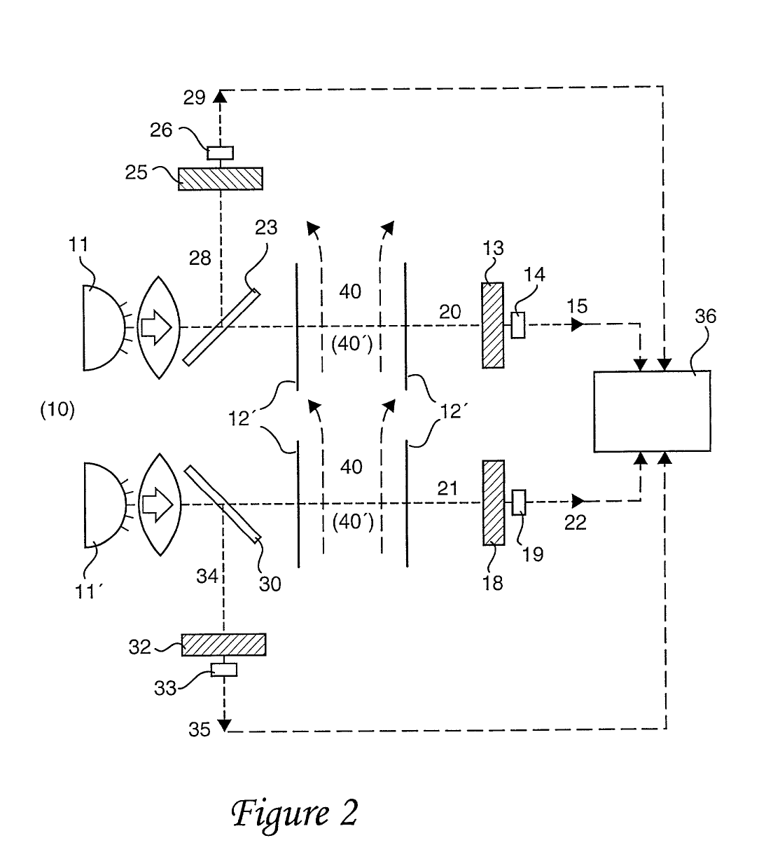

FIGS. 1 and 2 each schematically illustrates an apparatus according to a preferred embodiment of the invention for monitoring the concentration of a light absorbing substance.

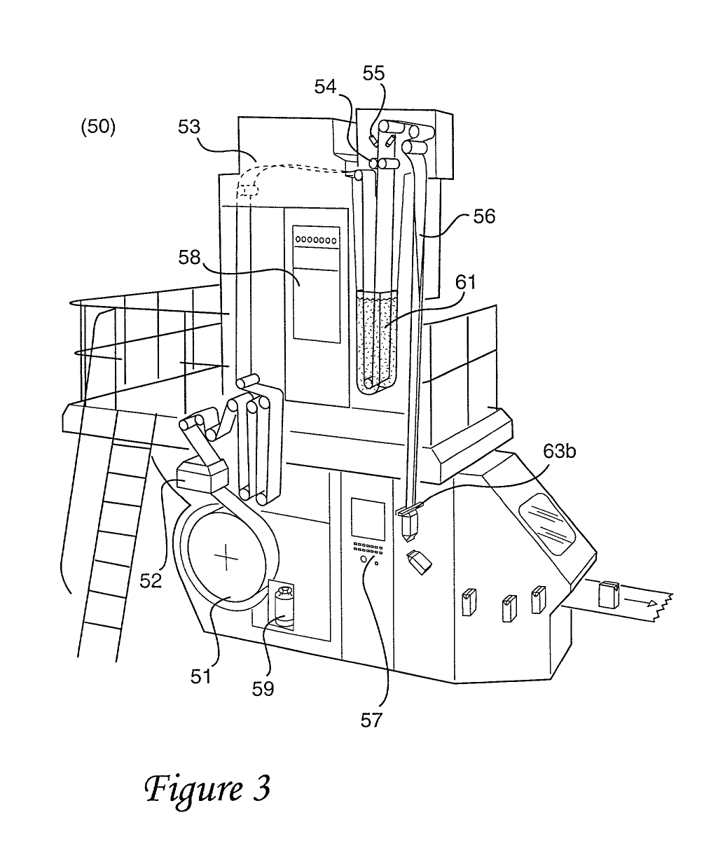

FIG. 3 schematically shows an example of a filling and packaging machine according to the invention, of a similar type to those commonly used for filling and packaging of liquid food products on the market today.

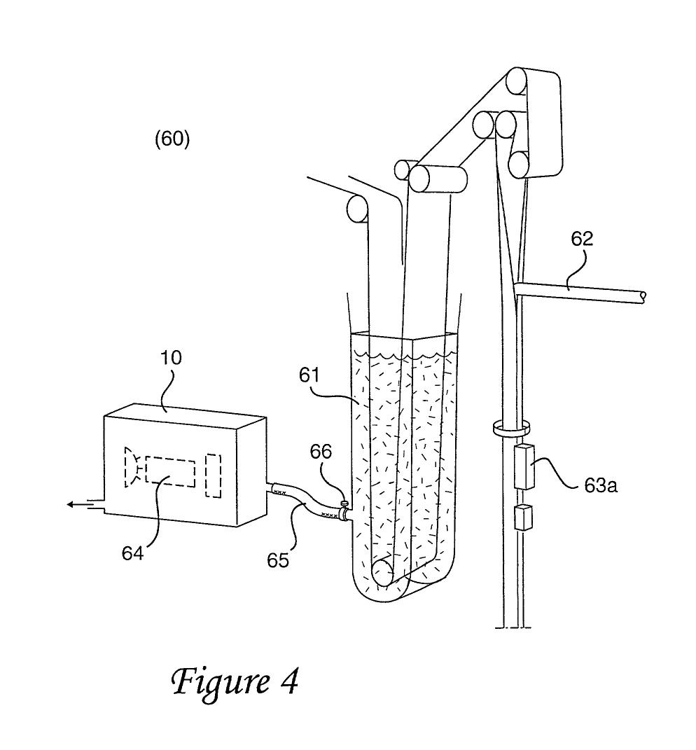

FIG. 4 shows in greater detail the sterilising unit of the packaging machine in FIG. 3.

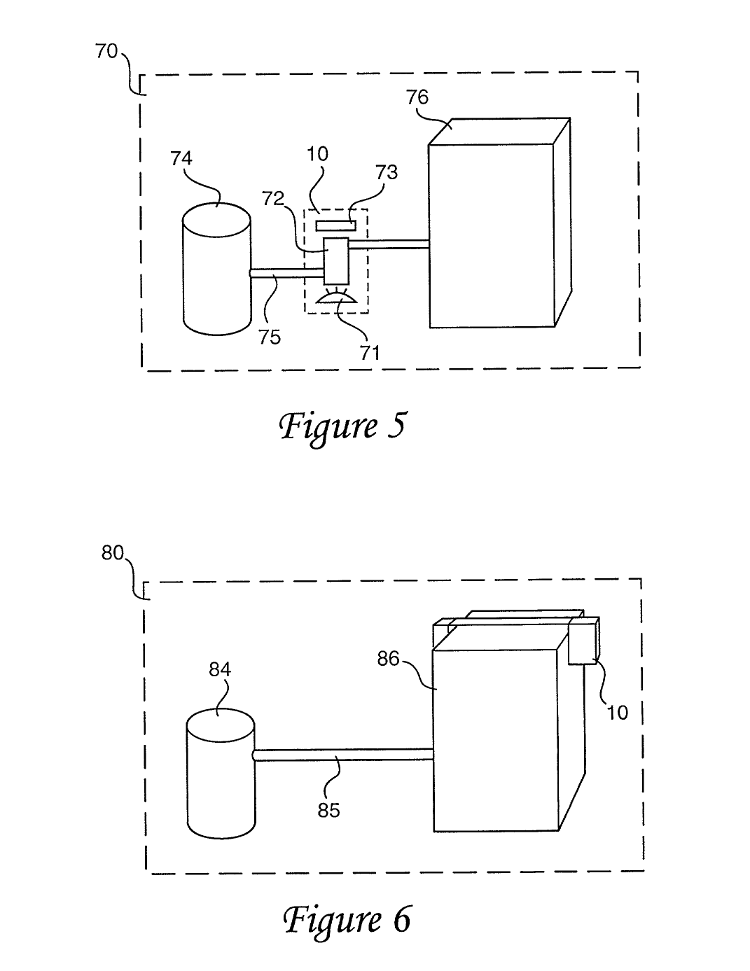

FIGS. 5 and 6 each schematically show an embodiment of a packaging and filling machine 70 or 80 respectively according to the invention, sterilising by means of a gas-phase sterilising medium, comprising a concentration-determining apparatus 10.

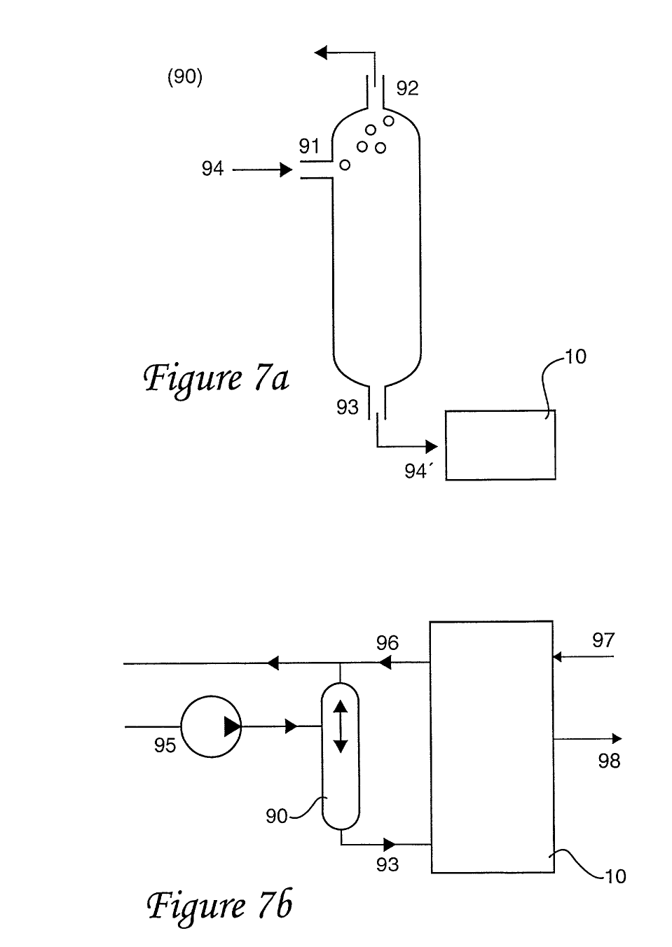

FIGS. 7a and 7b schematically illustrate a gas bubble reducing device 90 for reducing or eliminating gas bubbles in the sterilisation liquid and the connection of such a device to the concentration measurement apparatus 10, respectively.

Advantageously and in particular, the concentration of substances having a broad absorption band in the UV-spectrum, but having a light absorption at wavelengths longer than 385 nm that is close to zero, may be measured by means of the method and apparatus according to the present invention. Typical such substances are hydrogen peroxide and ozone.

In order to provide the light of the suitable wavelengths, there is provided one or more light sources (11).

Preferred light sources according to the invention are those providing light of wavelengths ranging from the shorter UV spectrum wavelengths UVB and UVC, i.e. from about 220 to about 320 nm as well as light from the visible range wavelengths, longer than about 385 nm. Examples of such light sources are lamps of the gas discharge type providing broad-spectrum light, e.g. a xenon lamp, or alternatively high or low-pressure mercury lamps. However, also UV-laser devices may be used according to the preferred embodiment of the invention. It is for example possible to provide UV-light of one or more predetermined wavelengths by means of one or more laser-diodes. In order to provide light from the visible spectra, a further visible light source must then be provided.

For light of other wavelengths, other light sources well known in the art may be used.

Most preferably, the light source is a low pressure mercury lamp of the types that are commercially available today, since it can provide a UV spectral line at a predetermined wavelength with minimal band width and high intensity as well as light in the visible spectra. The actual UV wavelength is approximately 254 nm, or more precisely 253,7 nm, and there is another distinct spectral line at about 313 nm. Light of other wavelengths may also be filtered off from the UV-source light beam. If desired, for example as may be in the case of a low-pressure mercury lamp, the light emitted from the lamp may be centred along a light beam path by means of a collimating lens (1). UV-light and visible light may be provided by at least two different sources (11, 11′) or by just the same source (11).

The measurement cell or monitoring space (12), containing the gas or liquid sample to be measured, has windows (12′) made of quartz glass or a similar, optically well functioning,, transparent material. The sample medium to be measured is preferably measured while flowing through a measurement cell. For substances that may be influenced by UV-radiation, such as ozone or hydrogen peroxide, it is desirable to measure the concentration in a flowing sample medium. The flow speed of the sample medium is then advantageously in the order of a hundred or a couple of hundred ml/min.

In a packaging and filling machine using gaseous sterilising media, the measurement apparatus can advantageously be built around a conduit or pipe for transfer of the gas flow into the sterilising zone. The walls of the conduit are then foreseen with windows (12′), for example made of quartz glass, in order to let the light pass through from the light source, outside of the conduit wall, into the gaseous flow and further through the window (12′) in the opposite conduit wall, into the respective light detector. A separate measurement cell positioned outside the normal conduit, and a separate loop in order to supply the measurement cell with sample medium, would then not be necessary. By measuring directly in the supply flow of the sample medium, a simpler construction of the apparatus when installed in a packaging machine is possible. Instead of measuring through a measurement cell, the light absorption is thus measured through a monitoring space. The distance between the two quartz windows constitutes the length of the monitoring path (L). In particular, in the case of hot gas-phase medium, a separate measurement loop generates problems in the form of condensation droplets on the monitoring space windows. In a sterilisation apparatus, the monitoring space may even be constituted by the sterilisation chamber itself. Quartz windows or the like are then positioned on the opposite walls of the chamber.

The sample medium (40), i.e. the sterilising medium, or a reference medium containing none, or substantially less, of the sterilising substance (40′), is flown through the measurement cell in such a rate that the light cannot influence the sterilising substance. The flow rate may actually be very low, but should preferably not be held to a stand still during UV-radiation, since some sterilising substance might then be caused to dissociate due to the high energy radiation.

The medium may be any liquid or gaseous medium that does not disturb the light absorption measurements according to the invention. Normally, sterilising media are aqueous or based on sterile air or air-containing hot steam. However, other alternatives are feasible, like for example a clean inert gas, such as nitrogen, or a sterilising solvent that would not be harmful to the packaged product or a safety risk in the packaging process environment. The first and second wavelengths should preferably be selected in such a way that the substance to be measured absorbs a sufficiently different amount of light at the two wavelengths. The medium itself should preferably absorb substantially less light, or none, at the same wavelengths as the substance to be measured.

The length of the measurement cell or the monitoring path (L) through the sample medium, i.e. the distance the light is transmitted through the sample medium, may be selected according to the desired measurement range, i.e. the range of concentrations to be measured, the specific medium and the specific measurement wavelength.

The monitoring path (L) has a first end at which the light source is positioned and a second end, on the opposite side of the monitoring space or the measurement cell from the light source, at which means for detecting the light transmitted through the sample medium is positioned.

Accordingly, in order to detect and measure the light transmitted through the sample medium, first and second detectors (14, 19) are positioned at the opposite side of the measurement cell, at the second end of the monitoring path. The first detector (14) is preferably adapted to detect UV-light at at least one predetermined first wavelength. Any standard detector preferably adapted to measure wavelengths of 220-320 nm is suitable, for example a UV-sensitive photodiode.

In order to limit the light transmitted through the sample to the selected predetermined measurement wavelengths, thus preventing disturbing light from other diffuse wavelengths entering the detector, it may be advantageous to position an optical filter (13) before the first detector (14) along the path of the light beam. Such a UV-light optical filter may advantageously be of the type band-pass filter. In the case of a light source emitting light of one distinct wavelength or range of wavelengths only, such as a laser diode, an optical filter may be omitted. Also, if the detector has the required range of spectral sensitivity, an optical filter may be superfluous.

The second detector (19) is preferably adapted to detect light at a predetermined second wavelength or range of wavelengths from the visible spectrum, i.e. wavelengths longer than about 385 nm, more preferably within the range from about 400 nm to about 700 nm. The second detector (19) is suitably a photo diode and has an optical filter (18) of the type visible cut-off or cut-on filter, in order to filter away all the UV-light and let only visible light through. In particular, when using a low-pressure mercury lamp, a second detector adapted to measure light of 436 nm and/or 546 nm is preferred, since it provides well defined spectral lines at these wavelengths.

The light emitted from the light source(s) may thus be transmitted through the sample medium via one single light beam containing light of several different wavelengths both from the UV- and the visible spectra (see FIG. 1), such as for example in the case of a mercury lamp. The light of the various wavelengths may also be provided by two or more light sources and then colleted into one common light beam only, by means of optical devices known in the art (mirrors, reflectors). Alternatively (see FIG. 2), light may be transmitted via two separate light beams, one for measurement at the first predetermined UV wavelength by means of the first detector, and the other for measurement at one or more second predetermined visible wavelengths or range of wavelengths, by means of the second detector. In the latter case, there may be an uncertainty in that the light beams are passing through different parts of the sample medium, or even through different measurement cells, and in that the amount of disturbing substances may be different (dust particles etc). The first case, i.e. with the light source(s) providing one single light beam is, thus, preferable according to the invention. In order to detect the light transmitted at two separate wavelengths, the main light beam may be divided into two light beams after having passed the sample medium. This may advantageously be achieved by means of a beam splitter (16) positioned at the second end of the monitoring path, along the path of the light beam before the detectors (14, 19) and, if present, the optical filters (13, 18). Such a beam splitter may be a mirror or a so-called beam splitter cube or another type of optical window, that is designed to let part of the light through and to reflect the other part of the light.

The beam splitter (16) accordingly divides the light beam into two separate light beams (20,21), thus providing light to the first and second detecting means respectively. The first light beam (20), providing light to the first detector (14), passes preferably through a first optical filter (13) before it reaches the detector, with the function to restrict the light entering the detector to the predetermined first wavelength(s). In the same way, the second light beam (21) preferably passes through a second optical filter (18), with the function to restrict the light entering the second detector (19) to the predetermined second wavelength(s).

Thus, by directing a beam of light from the light source through a sample of the fluid medium (40), along a monitoring path having the length (L), containing the substance to be measured as well as any interfering materials, detecting the intensity of the light transmitted (20) through the sample medium (40) at the first wavelength, and also directing light from the light source through the reference sample (40′), which contains no, or substantially less, of the substance to be measured, along a monitoring path having the same length (L), and then detecting the intensity of the light transmitted (20′) at the first wavelength through the reference sample (40′), first detector output signals (15 and 15′) are produced, for indication of the difference in light intensity of the light transmitted through the sample and reference sample respectively. By applying the Beer-Lambert equation to the relative values of the output signals, the concentration of the light absorbing substance may then normally be determined. According to the invention, the true concentration of the substance is determined by correction, by using the corresponding second detector output signals (22, 22′) from the same measurements at the second wavelength, in order to eliminate the influence from impurities in the sample (40).

The analogue detector output signals (15,22) are transferred to a conversion means for conversion into digital signals and then further transferred to a computing means (36) for calculation and evaluation of the concentration according to the Beer-Lambert equation. Optionally, the output signals may be computed in order to further providing input to an automatic concentration regulating system for control of the dosage of substance into the liquid or gas-phase medium. In order to be able to apply the Beer-Lambert equation, the intensity of the light transmitted through the sample medium as well as through the reference sample, i.e. the medium that is free, or substantially free, of the substance to be measured, should be measured. As previously mentioned, this may preferably be carried out either by switching the contents of one single measurement cell from sample to reference sample, once now and then. Alternatively, the reference sample may be measured in a separate measurement cell filled with the liquid or gaseous medium only (free of sample substance). The first case is preferred since it provides the highest reliability and accuracy. According to a preferred embodiment of the method of the invention, when measuring UV-sensitive substances such as ozone or hydrogen peroxide, the reference sample may be prepared in the same measurement cell as the sample medium, by stopping the flow of fresh clean sample medium through the cell for a short period of time, during which the sample medium is radiated by the UV-light. The UV-sensitive substance will thus be degraded, providing a liquid or gas-phase reference medium, free of the substance to be measured as well as of interfering material. Accordingly, an automatic calibration may be performed regularly while otherwise measuring the concentration of the substance in the flowing medium continuously.

The calculations in the computing means are preferably carried out according to the following scheme:

1) Traditionally, the concentration is determined by means of the Beer-Lambert equation, i.e.

C=1/εL * log (I_{UV(0)}/I_{UV})

where I_{UV(0)} is the intensity of UV-light transmitted through the reference sample, i.e. the medium only (40′), at the first predetermined UV-light wavelength(s) (first detector output signal 15′) and I_{UV} is the intensity of the light transmitted through the sample medium, i.e. the medium containing the substance to be measured as well as any interfering material (40), at the first predetermined UV wavelength(s) (first detector output signal 15).

2) However, according to the invention, the intensity of the transmitted light also varies due to impurities in the liquid or gaseous medium, such as dust and other more or less solid particles. Therefore the ratio of I_{UV(0)}/I_{UV} must be corrected by the ratio between (Iᵥᵢₛ₍₀₎/Iᵥᵢₛ), where Iᵥᵢₛ₍₀₎ is the intensity of light transmitted through the reference sample, i.e. the medium only (40′), at the second predetermined visible light wavelength(s) (second detector output signal 22′) and Iᵥᵢₛ is the intensity of the light transmitted through the sample medium, i.e. the medium containing the substance to be measured as well as any interfering material (40), at the second predetermined visible light wavelength(s) (second detector output signal 22).

Accordingly,

C=1/εL * log ((I_{UV(0)}/I_{UV})(Iᵥᵢₛ/Iᵥᵢₛ₍₀₎))

i.e.

C=1/εL * log (Iᵥᵢₛ/I_{UV}) - - - 1/εL * log(I_{vis(O)}/I_{UV(0)})

where the second term is determined at calibration and measurement through the reference sample and then may be stored in the computing means as a constant value. Thus, the ratio (Iᵥᵢₛ/I_{UV}) is continuously measured.

3) According to the invention, also the intensity of the light emitted from the lamp, but not transmitted through the sample medium is measured and transferred as detector output signals to the computer processing means. The purpose thereof is to compensate for the fact that the intensity of the light emitted from the lamp may vary in time due to ageing of the lamp or to variations in the voltage supply to the lamp. Such measurement may be necessary, depending on the quality of the lamp but also on the use and the purpose of the measurement and the requirements on accuracy of the concentration measured. It has proved to be highly desirable for the purpose of concentration measurements in the sterilisation of packaging materials, packages or equipment for food packaging purposes.

4) The ratio (I_{UV(0)}/I_{UV}) thus should be adjusted by the ratio between (I_{UVref(0)}/I_{UVref}) where I_{UVref(0)} is the intensity of UV-light emitted from the light source at the first predetermined UV-light wavelength(s) at the point in time when the reference sample is measured (third detector output signal 29′) and I_{UVref} is the intensity of the light emitted from the light source, at the first predetermined UV wavelength(s) at the point in time when the sample medium is measured (third detector output signal 29).

It may for some purposes be stipulated that the intensity of the light emitted from the light source varies in time equally at different wavelengths. Such a stipulation is, however, for most light sources not true, and will cause lower accuracy in the calculations of the concentration. In the case of a low-pressure mercury lamp and requirements on high accuracy, such as +/−35, preferably +/−2%, in the concentration measurements, such a stipulation is not recommended. Again, this is of course depending on the circumstances and purposes of the measurements. In particular, changes in the environment around the measurement apparatus, such as temperature changes, will also influence the function of the lamp and the intensity of the light differently, at different wavelengths. The ratio between the lamp intensities at different wavelengths does, thus, vary with changes in the surrounding temperature. Temperature changes are common in the environment of packaging and filling machines

5) Therefore, for improved accuracy in the measurements, the intensity of the light emitted from the light source should be measured at the first as well as at the second predetermined wavelength(s). Thus, the ratio (I_{UV(0)}/I_{UV}) should be further adjusted by the ratio between (I_{VISref(0)}/I_{VISref}) where I_{VISref(0)} is the intensity of light emitted from the light source at the second predetermined wavelength(s) (fourth detector output signal 35′) at the point in time when the reference sample is measured and I_{VISref} is the intensity of the light emitted from the light source, at the second predetermined wavelength(s) at the point in time when the sample medium is measured (fourth detector output signal 35).

6) Accordingly, the concentration can be calculated as

C=1/εL * log ((I_{UV(0)}/I_{UV})(Iᵥᵢₛ/Iᵥᵢₛ₍₀₎)(I_{UVref}/I_{UVref(0)})(I_{VISref(0)}/I_{VISref}))

i.e.

C=1/εL * log((I_{UVref}/I_{UV}) (I_{VIS}/I_{VISref}))−1/εL * log((I_{UVref(0)}/I_{UV(0)})(I_{VIS (0)}/I_{VISref(0)}))

wherein the second term is determined at calibration and measurements through the reference sample and then may be stored in the computing means as a constant value. Thus, only I_{UVref}, I_{UV}, I_{VIS}, and I_{VISref} need to be continuously measured.

The accuracy in the concentration measurements according to this preferred embodiment is +/−3%, preferably +/−2%, which is desired in the process of sterilisation of packaging materials.

When sterilising with a gas phase sterilising medium, compensation and recalculation may be done for variations of pressure and temperature.

Similarly, when the sterilising medium is a liquid, the influence of the temperature of the medium on its density may be compensated for.

In addition, the absorption coefficient for some liquid media may vary with the temperature at a given wavelength. In particular, in the case of hydrogen peroxide solution of a higher concentration (about 35 weight %) at ambient temperature, the concentration of the hydrogen peroxide solution may rise to about 45 weight % at a temperature increase to about 70° C., when measured at 313 nm wavelength. The relation between the concentration C and the absolute temperature T can then generally be expressed as 1/C=αe⁻¹/T, wherein α is a linear constant. At a wavelength of 254 nm, this effect is, however, negligible.

Accordingly, with reference to FIG. 1, the apparatus further may comprise a second beam splitter (23) and a third detecting means (24) including a third optical filter (25) and a third detector (26), the beam splitter (23) dividing the light from the light source into a main light beam (27) and a third light beam (28) and being positioned between the light source (11) and the first end of the monitoring path (L), the main light beam (27) being directed through the sample medium along the monitoring path, the third detecting means (24) being designed to measure UV-light of said first wavelength and being positioned along the third light beam (28), thus providing a reference output signal (29) (corresponding to I_{UVref(0)} and I_{UVref} respectively) for compensation for fluctuations in the intensity of light transmitted from the light source at said first wavelength. The third optical filter and detector are preferably identical to the first optical filter (13) and detector (14). The apparatus then further comprises a third beam splitter (30) and a fourth detecting means (31), including a fourth optical filter (32) and a fourth detector (33), the third beam splitter splitting off a fourth light beam (34) from the third light beam (28) and being positioned between the second beam splitter (23) and the third and fourth detecting means, the fourth detecting means (31) being designed to measure light of the second wavelength and being positioned along the fourth light beam (34), thus providing a reference output signal (35) (corresponding to I_{VISref(0)} and I_{VISref} respectively) for compensation for fluctuations in the intensity of light transmitted from the light source at the second wavelength.

The fourth optical filter and detector are preferably identical to the second optical filter (18) and detector (19). Thus, third and fourth detector output signals (29; 35) are provided, representing the intensity of the light emitted from the lamp at a certain point in time.

An alternative arrangement is, that two light beams are directed through two different but identical monitoring spaces (12), according to FIG. 2, using the same reference numbers for the corresponding items.

In FIG. 2, the light source (11), or the light sources (11, 11′) as the case may be, provides two main light beams (20, 21), each to be transmitted through a measurement cell (12) or through different monitoring spaces (12), both containing the sample medium and both having the same length of the monitoring path (L). At the second end of the monitoring path of the first measurement cell, along the light beam (20), is positioned a first detector (14) for detecting the intensity of the light transmitted at the first wavelength(s). Normally, the light first passes through a first optical filter (13) in order to restrict the light to be detected to light of the first wavelength(s) only. Similarly, at the second end of the monitoring path of the second measurement cell, along the light beam (21), is positioned a second detector (19) for detecting the intensity of the light transmitted at the second wavelength(s). Normally, the light first passes through a second optical filter (18) in order to restrict the light to be detected, to light of the second wavelength(s) only.

According to the preferred embodiment of the invention, the apparatus then further may comprise a first beam splitter (23) and a third detecting means (24) including a third optical filter (25) and a third detector (26), the beam splitter (23) dividing the light from the light source into the main light beam (20) and a third light beam (28) and being positioned between the light source (11) and the first end of the monitoring path (L), the main light beam (20) being directed through the sample medium along the monitoring path, the third detecting means (24) being designed to measure UV-light of said first wavelength and being positioned along the third light beam (28), thus providing a reference output signal (29) for compensation for fluctuations in the intensity of light transmitted from the light source at said first wavelength. The third optical filter and detector are preferably identical to the first optical filter (13) and detector (14). The apparatus then further may comprise a second beam splitter (30) and a fourth detecting means (31), including a fourth optical filter (32) and a fourth detector (33), the second beam splitter (30) splitting off a fourth light beam (34) from the second light beam (21) and being positioned between the light source (11) and second measurement cell, the fourth detecting means (31) being designed to measure light of the second wavelength and being positioned along the fourth light beam (34), thus providing a reference output signal (35) for compensation for fluctuations in the intensity of light transmitted from the light source at the second wavelength. The fourth optical filter and detector are preferably identical to the second optical filter (18) and detector (19). Thus, third and fourth detector output signals (29; 35) are provided, representing the intensity of the light emitted from the lamp at a certain point in time.

In both cases, as explained above, reference measurements may be performed either in still further separate measurement cells along separate light-beam paths or, preferably, in the same measurement cells by temporarily replacing the sample medium (40) with reference medium (40′).

The concentration measurement sensitivity range may be varied by varying the length of the monitoring path in the sample, i.e. the length of the measurement cell or the measurement space (L). A low concentration requires a longer monitoring path and vice versa. The length of the measurement cell usually varies from about 0,001 to about 20 mm, preferably from about 0,5 to about 5 mm, most preferably from about 0,5 to about 2 mm, when measuring ozone and when measuring hydrogen peroxide in aqueous solution. However, for measuring of hydrogen peroxide in gas-phase a longer monitoring path is required, such as from about 10 to about 200 mm, preferably 50-150 mm and most preferably 25-100 mm. The concentration detection limit is about 0,02 weight %, or expressed as 0,2 g/m³ in a gas-phase medium.

When the concentration in a gas-phase medium is measured “in-line” i.e. directly in the gas flow or in the sterilisation chamber in a machine, the longer monitoring paths (L) may advantageously be used.

For measurement of ozone or hydrogen peroxide in low concentrations, the mercury lamp emission wavelength of 254 nm is highly suitable, both in air/gas-phase and in aqueous solution. Well functioning detectors for this wavelength are the low sensitivity detectors, adapted for detection at 254 nm.

Only when measuring hydrogen peroxide in higher concentrations in aqueous solution, i.e. from the detection limit of about 1 up to about 50 weight-% or alternatively expressed up to about 500 g/l, a different type of detector may be required, such as for example a higher sensitivity detector, adapted for detection at a wavelength at which the hydrogen peroxide absorption is lower than at 254 nm. The optical filter and detector may then be adapted to detect UV-light absorption at a wavelength such as 294, 297 or 313 nm. Preferably, since hydrogen peroxide has an adequate absorptivity at this wavelength, higher concentrations are measured at 313 nm. The length of the monitoring path is preferably about 1 mm.

Aqueous hydrogen peroxide in lower concentrations, such as from the detection limit of about 0,02 to about 2 weight-%, is preferably measured at 254 nm and through a measuring cell having the length of about 1 mm.

Concentrations of hydrogen peroxide in gas-phase or aqueous vapour, up to about 170 mg/l, is preferably measured at 254 nm, the length of the monitoring path being from about 25 to about 100 mm.

Ozone in aqueous medium in concentrations of up to about 160 mg/l is preferably measured at 254 nm through a measuring cell having the length of up to about 2 mm, preferably about 1 mm.

Ozone in gas-phase concentrations up to about 160 mg/l is preferably also measured at 254 nm through a measuring cell having the length of up to about 2 mm, preferably about 1 mm.

If hot or warm liquid sterilisation medium is used, it may be necessary to compensate for the higher temperature in the calculation of the concentration of sterilising substance, depending on which sterilising substance is used. The relation between the concentration C and the absolute temperature T can generally be expressed as 1/C=α e^{-1/T}, wherein α is a linear constant. In particular regarding hydrogen peroxide, this effect may have to be considered.

FIG. 3 together with FIG. 4 schematically shows one common example of a filling and packaging machine according to the invention, which is available on the market today. The machine is in particular suitable for packaging of food products into Tetra Brik® packages, but in principle such a packaging machine may be adapted to any kind of packaging material web- or blank-fed apparatus. The packaging machine comprises i.e. a sterilisation unit 60, further, and in greater detail, schematically described in FIG. 4. According to this particular embodiment, the sterilisation unit 60 comprises a deep bath of sterilisation liquid 61, through which the packaging material passes on its way forward through the machine. Most commonly, the deep bath is filled with hot aqueous hydrogen peroxide solution. The machine further comprises a reel or holder/feeder 51 for the packaging material to be used. In an optional splicing station 52, the edges of the packaging material web may be prepared and modified, depending on the longitudinal sealing method, in order to later achieve a gas-tight and durable longitudinal seal. In a further strip applicator station 53, a plastic strip of a durable material, having gas barrier properties, may be applied onto one of the edges of the web. Later at the longitudinal sealing stage, this is welded to the opposite edge, resulting in a tight and durable seal.

However, before the longitudinal sealing station, the packaging material passes the sterilisation unit 60 and the deep bath of sterilising medium 61. On its way up from the deep sterilising bath, the packaging material web passes rollers 54, which remove the hydrogen peroxide from the packaging material, and nozzles 55 for hot, sterile air, to dry the packaging material.

The dry, sterilised packaging material is then fed forward to the tube-forming station 56, where the packaging material web is folded into the shape of a continuous tube. The two longitudinal edges of the web are welded together by welding elements 63a (see FIG. 4). The food product, in this case a liquid food product, is filled into the tube by means of a filling pipe 62 (see FIG. 4). The packages are then transversally sealed beneath the surface of the filled liquid by means of heat welding at 63b. The heat is applied by means of sealing jaws, which also are shaped for cutting of the sealed packages from each other. Most commonly, the heat welding takes place by means of induction heat, but may also be carried out by means of ultra-sonic sealing or any other sealing method known in the art.

In a final folding step, the sealed off packages are shaped into its final shape and the top and bottom flaps are sealed onto the package. Thereafter the finished packages are discharged from the machine.

The running of the machine is regulated from a control panel 57, and the most of the electrical system of the machine is located at 58.

The sterilising medium is supplied within a closed system from a container 59, situated at a suitable place in the machine.

The apparatus (10) for determining the concentration of the sterilising substance in the sterilising medium according to the invention, is suitably situated in connection to the sterilising unit, as can be seen in FIG. 4. Samples of the sterilising liquid may be directly transferred from the bath to the measurement cell 64 of the apparatus 10, by means of a small pipe or hose 65, either continuously or at regular intervals by means of a regulating valve 66.

FIG. 5 shows schematically a first embodiment of how a concentration-determining apparatus 10 according to the invention may be applied in a packaging and filling machine 70, using sterilisation by means of a gas-phase sterilising medium. The apparatus 10 comprises a light source 71, a measurement cell 72 and a detector 73, as described in FIGS. 1 and 2.

The sterilising agent together with air, or together with a mixture of air and moisture, is heated and evaporated in an evaporating chamber 74, and fed through a connecting pipe or hose 75 to the concentration measurement apparatus 10. The concentration measurement is thus carried out directly in the flow of the hot sterilising medium on its way to the sterilising chamber 76.

FIG. 6 shows schematically a second embodiment of how a concentration-determining apparatus 10 according to the invention may be applied in a packaging and filling machine 80, using sterilisation by means of a gas-phase sterilising medium.

The sterilising medium is in this case evaporated in the evaporating chamber 84 and directly fed via a connecting hose or pipe 85 to the sterilisation chamber 86. The apparatus 10 is applied directly onto the sterilisation chamber and measuring through windows located in the opposite walls of the sterilisation chamber.

In order to reduce the amount of gas bubbles in the sterilisation liquid, especially at higher concentrations, such as about 35 weight % of H2O2 and above, and especially at higher temperatures, i.e. hot liquid, a bubble reducing device or a so-called bubble trap or bubble filter may be included in the concentration measurement equipment. Preferably, the bubble-reducing device (90) comprises a cylinder having one in-let 91 and two out-lets 92,93 as illustrated in FIG. 7a. The cylinder is about 80-150 mm high and has a diameter of about 30 mm. The in-let 91 is positioned on the sleeve surface of the cylinder, while the two out-lets are each positioned at respective top 92 and bottom 93 of the cylinder. The sterilising liquid 94 is led through the cylinder via the in-let and the two out-lets and is thus allowed to rest for a while in the cylinder. Gas bubbles in the liquid have time to rise to the top of the cylinder and the top out-let 92 and the liquid 94′ is thus cleared from bubbles at the bottom out-let 93 and led to the concentration monitor. The mixture of gas and liquid 94″ that exits through the top out-let 92 is led back to the return flow of sterilising liquid.

FIG. 7b shows how the bubble-reducing device is connected in the flow of sterilising liquid to and from the concentration measurement device 10. The measurement flow of sterilising liquid is pumped into the cylinder in order to ascertain sufficient flow speed through the cylinder out-lets. The bottom out-let 93 conducts the liquid to the in-let 95 of the concentration monitoring equipment 10. The liquid from the top out-let 92 is joined with the return flow from the concentration monitoring equipment 10.

Accordingly, the invention provides an optimal method and an apparatus, providing improved accuracy and reliability, suitable for control of concentration of sterilising substance in the process of sterilisation of a packaging material or a package for subsequent filling with food product. Furthermore, an automatic and continuous method and an apparatus for such automatic and continuous concentration measurement is provided.

By comparison of the absorbance of light at two different wavelengths, one preferably being in the UV-range and the other preferably being selected from the visible range of the spectrum (for the Hg-lamp suitably at longer wavelengths than 385 nm), the disturbing influences of interfering materials such as dust particles, dirt and bubbles may be compensated for. By also measuring the intensity of the light emitted from the light source but which has not yet passed through the measurement sample, simultaneously with the measurements of the absorbance of the light transmitted through the sample, at each wavelength measured, the true concentration may be determined by improved accuracy.

1. A method for determining the concentration of a substance in a sample in the presence of an interfering material, comprising at least the steps of directing light from a light source through said sample, measuring the absorbance of said light at a first wavelength or range of wavelengths, at which light is absorbed by said substance and interfering material, and at a second wavelength or range of wavelengths, at which light is absorbed by said interfering material but substantially not by said substance, and deriving from said measurements the required determination of the concentration of said substance corrected for the presence of said interfering material, wherein to compensate for variations in the intensity of light emitted from said light source, measurements are made at each said wavelength(s) of the intensity of light from said light source which has not passed through said sample simultaneously with said measurements of absorbance, and the said determination of the concentration of said substance is corrected for errors resulting from said variations in emitted light intensity on the basis of said measurements of light intensity.

2. Method according to claim 1, wherein said light includes light from the UV spectrum as well as from the visible spectrum.

3. Method according to any one of claims 1 or 2, wherein said first wavelength(s) is selected from between about 220 nm and about 320 nm.

4. Method according to any one of claims 1-3, wherein said second wavelength(s) is selected from wavelengths about 385 nm and longer.

5. Method according to claim 1 for determining the concentration in a liquid or gas-phase medium (40), of a substance absorbing UV-light at one or more first wavelength(s) between about 220 and about 320 nm, in the presence of an interfering material, comprising the steps of
a) providing a light source (11) emitting light including said first wavelength(s) and at least one second wavelength or range of wavelengths of about 385 nm or longer;
b) directing light from the light source through a sample of a fluid medium (40), containing the substance to be measured as well as interfering material, along a monitoring path having the length (L);
c) measuring the intensity of the light transmitted (20) at said first wavelength and at said second wavelength respectively, through the sample medium (40);
d) directing light from the light source through a reference sample of the liquid or gas-phase medium (40′), containing substantially less of the substance to be measured, along a monitoring path having the same length (L);
e) measuring the intensity of the light transmitted (20′) at the first wavelength(s), and the second wavelength(s) respectively, through the reference sample (40′);
f) thus producing first detector output signals (15; 15′) for indication of the difference in light intensity from sample and reference sample respectively at said first wavelength(s) and second detector output signals (22; 22′), for the corresponding indication of the difference in light intensity at said second wavelength(s);
g) determining the concentration of the UV-absorbing substance from the relative values of the output signals (15, 15′) by means of the Beer-Lambert equation,
h) correcting the value of the concentration determined in g), by means of the second detector output signals (22, 22′), thus eliminating the influence from impurities in the sample (40), wherein
i) the intensities of the light from said light source which has not passed through said sample medium (40) or reference sample medium (40′) respectively, at the first and second wavelength(s) respectively, are detected simultaneously with the measurements in c) and e), and
j) the said determination of the concentration in h) is corrected for errors resulting from variations in the intensity of the light emitted from the light source, on the basis of the measurements in i).

6. Method according to any one of the preceding claims, wherein the light absorbing substance is selected from the group consisting of ozone and hydrogen peroxide.

7. Method according to any one of the preceding claims, wherein the fluid medium (40) is an aqueous medium.

8. Method according to any one of the preceding claims, wherein the fluid medium (40) is based on air and/or aqueous vapour.

9. Method according to any one of claims 1-8, wherein the light absorbing substance is hydrogen peroxide in an aqueous medium, the first wavelength is about 313 nm, and the second wavelength is selected from about 436 or 546 nm.

10. Method according to any one of claims 1-8, wherein the light absorbing substance is hydrogen peroxide in a gas-phase medium, the first wavelength is about 254 nm and the length of the monitoring path (L) through the sample medium (40) is from 10 to 250 mm.

11. Method according to any one of claims 1-8, wherein the light absorbing substance is ozone, the first wavelength is about 254 nm and the length of the monitoring path (L) through the sample medium (40) is from 0,5 to 5 mm.

12. Method according to any one of the preceding claims, wherein the sterilising medium is a liquid medium and the amount of gas bubbles is reduced by separating gas bubbles from the liquid before determining the concentration.

13. Apparatus (10) for determining the concentration of a substance in a sample (40) in the presence of an interfering material, comprising at least a light source (11) and means for directing light from the light source through said sample,
means (14) for measuring the absorbance of said light transmitted through the sample at a first wavelength or range of wavelengths, at which light is absorbed by said substance and interfering material, and (19) at a second wavelength or range of wavelengths, at which light is absorbed by said interfering material but substantially not by said substance, and means (36) for determining the concentration of said substance, on the basis of said measurements of light absorbance,
which apparatus, in order to compensate for variations in the intensity of light emitted from said light source, further comprises
means (26, 33) for measuring the intensity of light from said light source which has not passed through said sample at each said wavelength simultaneously with said measurements of absorbance, and
means (36′) for correcting said determined concentration for errors resulting from said variations in intensity of light emitted from the light source, on the basis of said measurements of light intensity.

14. Apparatus according to claim 13, wherein the light source (11) emits light including a first wavelength or range of wavelength(s) selected from between about 220 nm and about 320 nm, as well as a second wavelength or range of wavelength(s) of about 385 nm or longer.

15. Apparatus according to claim 12, wherein the light source (11) is a low pressure mercury lamp.

16. Apparatus (10) for determining the concentration of a substance absorbing UV-light at one or more first wavelength(s) of between about 220 and about 320 nm, in a fluid medium (40) containing the substance to be measured, in the presence of an interfering material, comprising at least
a) a light source (11) emitting light including said first wavelength(s) and at least
one second wavelength or range of wavelength(s) of about 385 nm or longer,
b) a monitoring path having the length (L) traversing the medium (40),
c) means for directing the light through said medium (40) over said monitoring path,
d) at least one first detector (14) being adapted to measure the intensity of the UV-light transmitted over the monitoring path at the first wavelength(s), the first detector(s) providing a first, first detector output signal (15) representing the intensity of the light, at said first wavelength(s), transmitted through a sample of the liquid or gas-phase medium (40) containing the substance to be measured as well as interfering material, and a second, first detector output signal (15′) representing the intensity of the light at said first wavelength(s), transmitted through a reference sample of the liquid or gas-phase medium (40′), containing none, or substantially less, of the substance to be measured,
e) at least one second detector (19) being adapted to measure the intensity of the light transmitted over the monitoring path at the second wavelength(s), the second detector(s) providing a first, second detector output signal (22) representing the intensity of the light at said second wavelength(s), transmitted through a sample of the fluid medium (40) containing the substance to be measured as well as interfering material, and a second, second detector output signal (22′) representing the intensity of the light at said second wavelength(s), transmitted through a reference sample of the liquid or gas-phase medium (40′), containing none, or substantially less, of the substance to be measured, and
f) computing means (36) for deriving the determined concentration of the UV-absorbing substance from the relative values of the output signals by applying the Beer-Lambert equation, which apparatus, in order to compensate for variations in the intensity of light emitted from said light source, further comprises
g) at least one third detector (26) being designed to measure the intensity of the UV-light before being transmitted through the sample, at the first wavelength(s), simultaneously with the measurements by the first detector(s),
h) at least one fourth detector (33) being designed to measure the intensity of the light before being transmitted through the sample, at the second wavelength(s), simultaneously with the measurements by the second detector(s), and
i) computing means (36′) for correcting said determined concentration for errors resulting from said variations in intensity of light emitted from the light source.

17. Apparatus according claim 16, for determining the concentration of ozone, wherein the length (L) of the monitoring path is from 0,5 to 5 mm and the first and third detectors (14, 26) are adapted to measure UV-light of 254 nm.

18. Apparatus according to claim 16, for determining the concentration of hydrogen peroxide in a gas-phase medium (40), wherein the length (L) of the monitoring path is from 10 to 250 mm and the first and third detectors (14, 26) are adapted to measure UV-light of 254 nm.

19. Apparatus according to claim 16, for determining the concentration of hydrogen peroxide in an aqueous medium (40), wherein the length (L) of the monitoring path is from 0,5 to 5 mm and the first and third UV-detectors (14, 26) are adapted to measure UV-light of 313 nm.

20. Apparatus according to any one of claims 13-19, which further includes a device 90 for reducing the amount of gas bubbles in a sterilising liquid medium.

21. Method for packaging of a food product into packages, at least comprising the steps of sterilising a packaging material or packages by a sterilising medium containing a sterilising substance, filling of the sterilised packages with a food product and sealing of the packages, further comprising the method for determining the concentration of the sterilising substance in a sample of the sterilising medium, comprising at least the steps of
directing light from a light source through said sample,
measuring the absorbance of said light at a first wavelength or range of wavelengths, at which light is absorbed by said sterilising substance, and at a second wavelength or range of wavelengths, at which light is absorbed by said interfering material but substantially not by said sterilising substance, and
deriving from said measurements the required determination of the concentration of said sterilising substance corrected for the presence of said interfering material in the sterilising medium,
wherein to compensate for variations in the intensity of light emitted from said light source,
measurements are made at each said wavelength(s) of the intensity of light from said light source which has not passed through said sample of sterilising medium, simultaneously with said measurements of absorbance,
and the said determination of the concentration of said substance is corrected for errors resulting from said variations in emitted light intensity on the basis of said measurements of light intensity.

22. Arrangement (50; 70; 80) for packaging of a food product into packages, at least comprising means for sterilisation of a packaging material or a formed package by a sterilising substance in a sterilising medium (60), means for filling the packages with a food product (62) and means for sealing the packages (63a; 63b), further comprising an apparatus (10) for determining the concentration of the sterilising substance in the presence of an interfering material in the sterilising medium (40; 61), which apparatus comprises at least
a light source (11) and means for directing light from the light source through a sample of said sterilising medium (40),
means (14) for measuring the absorbance of said light at a first wavelength or range of wavelengths, at which light is absorbed by said sterilising substance, and (19) at a second wavelength or range of wavelengths, at which light is absorbed by said interfering material but substantially not by said sterilising substance and means (36) for determining the concentration of said substance on the basis of said measurements of light absorbance,
which apparatus, in order to compensate for variations in the intensity of light emitted from said light source, further comprises
means (26, 33) for measuring the intensity of light from said light source which has not passed through said sample, at each said wavelength simultaneously with said measurements of absorbance, and
means (36′) for correcting said determined concentration for errors resulting from said variations in intensity of light emitted from the light source, on the basis of said measurements of light intensity.
